(19) United States
(12) Patent Application Publication
(10) Pub. No.: US 2022/0375221 A1
(43) Pub. Date: Nov. 24, 2022

(54) VIDEO CAPTION GENERATING APPARATUS AND METHOD

(71) Applicant: INDUSTRY-ACADEMIC COOPERATION FOUNDATION CHANGWON NATIONAL UNIVERSITY, Gyeongsangnam-do (KR)

(72) Inventors: JEONG WON CHA, Gyeongsangnam-do (KR); Da Sol PARK, Gyeongsangnam-do (KR)

(21) Appl. No.: 17/773,194

(22) PCT Filed: Dec. 11, 2019
(86) PCT No.: PCT/KR2019/017428

§ 371 Date: Apr. 29, 2022

(30) Foreign Application Priority Data
Nov. 13, 2019 (KR) 10-2019-0144855

(51) Int. Cl. G06V 20/40; G06V 10/74; H04N 21/488

(52) U.S. Cl. CPC G06V 20/41; G06V 10/761; H04N 21/4884

(57) ABSTRACT

The disclosure is for a video caption generation apparatus and method thereof to generate a natural language sentence explaining a video used as input. The disclosure is configured by including an embedding unit to perform a video embedding and a category information embedding, a stack embedding encoder block unit to select a feature by utilizing the embedded video vector and category vector, a video-category attention unit to receive a result of the stack embedding encoder, to generate a similarity matrix and a feature matrix for a video and category information, and to provide a final encoding result, and a decoder module to generate a sentence by utilizing the final encoding result.

### TECHNICAL FIELD

The following description relates to a video caption generation apparatus, especially to a video caption generation apparatus and method thereof to generate natural language sentences explaining a video that is used as an input with implementing convolution and attention mechanism.

### BACKGROUND ART

Generating a video caption may be regarded as generating a natural language sentence to explain video contents used as an input. A sentence is usually generated through 2 processes in the generating a video caption.

The first process is extracting characteristics from an input video. The extracting process includes extracting characteristics by generating the video as n frame images per second and generating features by utilizing the images. The second process is generating sentences by utilizing the extracted characteristics. In order to generate a video caption in accordance with the processes, characteristics are extracted utilizing Convolution Neural Network (CNN) after dividing them into each frame.

However, 2D CNN method utilizing the convolution neural network is only applied to a single image and cannot use time information such as a video. 3D CNN has been suggested to tackle the issue.

The 3D CNN may have information about continuous frames and learn how to encode time information. However, the 3D CNN desires a complex process to output natural language sentences, and accordingly, it takes a long time. That is, the 3D CNN method has a slow learning speed and high costs, and it has a difficulty to learn a network with a deep hidden layer.

### DISCLOSURE

### Technical Problem

The disclosure may solve the above problems and provide a video caption generation apparatus and method thereof to generate natural language sentences explaining a video with a simpler way than a typical 3D CNN. That is, the disclosure is to generate a video caption without using a complex method such as the typical 3D CNN.

In the disclosure, a generation of a natural language sentence may utilize a convolution and an attention mechanism.

The disclosure may be also applied to a field such as visual QA besides generating a video caption.

### Solution to Problem

In a general aspect, a video caption generating apparatus in accordance with one or more embodiments of the disclosure may include an embedding unit to perform a video embedding and a category information embedding; a stack embedding encoder block unit to select a feature by utilizing the embedded video vector and category vector; a video-category attention unit to receive a result of the stack embedding encoder, to generate a similarity matrix and a feature matrix for a video and category information, and to provide a final encoding result; and a decoder module to generate a sentence by utilizing the final encoding result.

The embedding unit may generate an input video signal as n images and a frame vector through a convolution.

The category information embedding may be generated as a distributed representation by utilizing a word embedding and a character embedding.

The stack embedding encoder block unit may include a position encoding, a layer normalization, a depthwise separable convolution layer, a self-attention, and a feedforward layer.

The video-category attention unit may calculate a similarity matrix (S), a normalized similarity matrix (S′), a video-category similarity matrix (V2C), and a category-video similarity matrix (C2V) by utilizing a video vector and a category information vector.

The decoder module may generate a caption by repeating a process of predicting a next word from a lastly output word and a result vector of an encoder module.

In another general aspect, a video caption generating method in accordance with one or more embodiment of the disclosure may include an embedding operation to process a frame of an input video and to generate an embedding of category information; a stack embedding encoder operation to select a useful feature by utilizing an embedded video vector and category vector; a video-category information attention operation to generate a similarity matrix and a feature matrix for a video and category information by utilizing the selected feature information; a self-attention operation to generate a final encoder result by directly adding a video vector and a category vector into a calculation; and a decoder operation to generate a sentence by utilizing the generated encoder result.

The stack embedding encoder operation may include a position encoding operation to apply a weighting according to a frame or word position that appears in video category information; a layer normalization operation to normalize a distribution of each hidden state and to enable a rapid learning; a depthwise separable convolution operation repeated as much as predetermined number of layers; a self-attention operation to generate an embedding by discovering a pair of video and category information for a video and category information that are input respectively, to express oneself appropriately; and a feedforward layer operation to uniformly mix a self-attention that each head generates in order to prevent an inclination.

The video-category information attention operation may include obtaining a similarity matrix (S) by utilizing a video (V) and category information (C); obtaining a normalized similarity matrix (S′) having a softmax for each column by utilizing the similarity matrix (S); calculating a video-category similarity (V2C) by utilizing the normalized similarity matrix (S′) and the category information vector; and calculating a category-video similarity (C2V) by utilizing the similarity matrix (S), the normalized similarity matrix (S′), and the video vector (V).

### Effects of Invention

According to a video caption generating apparatus and method of the disclosure, without a complex process such as 3D CNN, a video caption (natural language sentence) explaining a video used as an input may be generated by utilizing a convolution and attention mechanism.

Accordingly, it may be more convenient compared with a typical case, and a learning speed may become rapid. Costs may be also reduced.

### DESCRIPTION OF DRAWINGS

FIG. 1 is a block diagram of a video caption generation apparatus in accordance with one or more embodiments of the disclosure.

FIG. 2 is a flow chart describing a video caption generation method in accordance with one or more embodiments of the disclosure.

FIG. 3 is a detailed flow chart of a stack embedding encoder operation of FIG. 2.

FIG. 4 is a detailed flow chart to obtain a matrix in a video-category attention process of FIG. 2.

### BEST MODE FOR IMPLEMENTATION OF THE INVENTION

Throughout the drawings and the detailed description, the same reference numerals refer to the same elements. The drawings may not be to scale, and the relative size, proportions, and depiction of elements in the drawings may be exaggerated for clarity, illustration, and convenience.

The following detailed description is provided to assist the reader in gaining a comprehensive understanding of the methods, apparatuses, and/or systems described herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

A detailed description is given below, based on attached drawings.

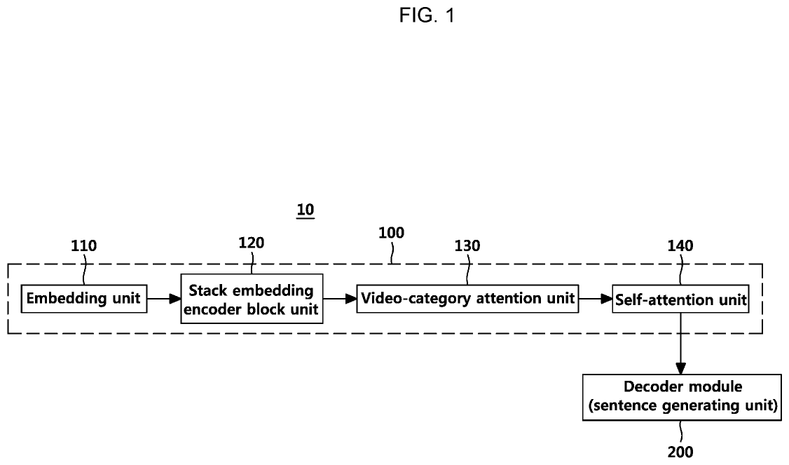

FIG. 1 is a block diagram of a video caption generation apparatus in accordance with one or more embodiments of the disclosure.

A video caption generation apparatus (10) of the disclosure may include an encoder module (100) and a decoder module (200). The encoder module (100) may include an embedding unit (110), a stack embedding encoder block unit (120), a video-category attention unit (130), and a self-attention unit (140). The decoder module (200) may generate a sentence by implementing a result of the encoder module.

Each configuration will be described.

The embedding unit (110) may process a video as a frame by utilizing a video and category information used for the video. That is, the embedding unit may perform a video embedding and category information embedding. The video embedding may perform a frame division operation to generate an input video signal as n images and generate a frame vector through a convolution afterwards. The convolution may utilize a pre-learned network result of ImageNet.

In one example, the category information embedding may be generated as a distributed representation by utilizing a word embedding and character embedding. The word embedding and the character embedding may learn an embedding value according to a learning process with a random configuration. An embodiment may utilize a learned word and character embedding.

According to an embodiment, the word embedding may avoid learning through a back-propagation. The character embedding may allow learning by the back-propagation, generate a vector through a CNN and max-over-time-pooling, connect and utilize a result vector and a word vector generated through a highway network. The max-over-time-pooling may generate a feature map as much as the number of CNN's filters and extract the most significant characteristic for each filter. Since the highway network does not desire a calculation such as a linear calculation or activation that are desired to be performed in a certain layer when passing the corresponding layer inside the network, the highway network may obtain a rapid learning.

In one example, the stack embedding encoder block unit (120) may perform 5 operations: i) position encoding, ii) layer normalization, iii) depthwise separable convolution layer, iv) self-attention, and v) feedforward layer. Herein, the layer normalization operation and the depthwise separable convolution layer operation may be repeated as much as predetermined number set up by a user. Functions of the stack embedding encoder block unit will be described below.

The video-category attention unit (130) may obtain 4 matrixes by utilizing a video vector and a category information vector and generate the final encoding result.

In one example, the self-attention unit (140) may be further connected to the video-category attention unit (130). In this example, the self-attention unit (140) may generate the final encoding result by utilizing an output vector that is obtained by the stack embedding encoder block unit (120)'s repeating with a predetermined number. That is, by directly adding the video vector and the category vector into a calculation, the final encoder result may be generated.

The 4 matrixes may refer to a similarity matrix (S), a normalized similarity matrix (S′), a video-category similarity (V2C), and a category-video similarity (C2V). A related process will be described below.

Meanwhile, the decoder module (200) may generate an actual sentence by utilizing the result vector of the encoder module (100). That is, the decoder module 200 may predict a next word (Yₜ) from the result vector (V_{encoder}) of the encoder and a lastly output word (Yₜ₋₁) and generate a caption for a video by repeating the above process.

The decoder module (200) may set the initial state of the decoder module (200) by utilizing the result vector of the encoder.

### Method for Carrying out the Invention

A method to generate a video caption will be described with utilizing the above-configured video caption generation apparatus.

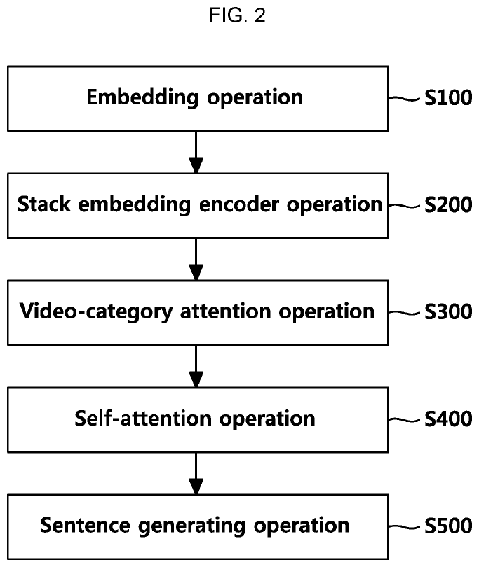

As illustrated in FIG. 2, the embedding unit (110) may perform an embedding operation (s100). The embedding operation (s100) may include the video embedding and the category information embedding. The video embedding may refer to a process to generate n images for an input video through the frame division operation and to generate a frame vector through the convolution. The category information embedding may be generated as the distributed representation by utilizing the word embedding and the character embedding. That is, by expressing a video to a vector and generating a vector through the word embedding, category information may be simultaneously received.

Meanwhile, when embedding the category information, the word embedding may avoid learning through a back-propagation. On the other hand, the character embedding may allow learning by the back-propagation. The character embedding may generate a vector through a CNN and max-over-time-pooling, connect and utilize the result vector and the word vector generated through a highway network. The max-over-time-pooling may generate a feature map as much as the number of CNN's filters and extract the most significant characteristic for each filter. Since the highway network does not desire a calculation such as a linear calculation or activation that are desired to be performed in a certain layer when passing the corresponding layer inside the network, the highway network may obtain a rapid learning. Therefore, the disclosure may utilize a learned word and character embedding.

When the embedding operation is completed, the stack embedding encoder block unit (120) may perform a stack embedding encoder operation (s200) to select a useful feature by utilizing an embedded video vector and category vector. In one example, the stack embedding encoder operation (s200) may include 5 operations.

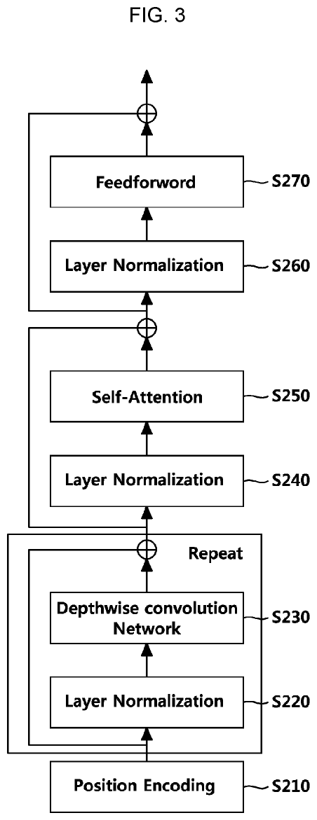

The stack embedding encoder operation (s200) is described referring to FIG. 3. FIG. 3 includes a calculation process of a vector that is used as an input and an output vector.

First of all, by performing the position encoding, a weighting may be applied according to a frame or a word position appearing in a video category (s210). Since the video and category information do not contain position information, the process may refer to adding position information through sine function and cosine function among trigonometrical functions in order to utilize the position information.

Secondly, the layer normalization may be performed (s220). Accordingly, distributions of each hidden state may be normalized, and values of gradient may have stabilized values, resulting in a rapid learning.

Thirdly, a depthwise separable convolution network operation may be performed (s230). The separable convolution may be performed repeatedly as much as predetermined number of layers. The convolution may be a combination of a depthwise convolution that performs a convolution independently for each channel and a pointwise convolution that combines multiple channels into a new channel through 1D CNN.

Likewise, the depthwise separable convolution network operation with 2 stages may have smaller calculation amount compared with a regular convolution network. Therefore, a learning speed may become rapid. After that, the layer normalization may be performed again (s240).

In one example, the secondary operation of layer normalization and the third operation of depthwise separable convolution operation may be repeated as much as a predetermined number set up by a user.

Fourthly, the self-attention operation may be performed (s250). The process may discover a video and category information to express oneself appropriately for the video and category information that are input respectively, and may generate an embedding through that. In one example, the self-attention may apply a scaled dot-product attention and a multi-head attention. The scaled dot-product attention may dot-product a gap between the video and category information as inputs, re-dot-product the video and category information by an attention obtained through a softmax, and discover a significant part. The multi-head attention may apply attentions by dividing attentions by the number of heads in the entire dimension based on rows of a vector, and then combine the attentions. The layer normalization may be performed again afterwards (s260).

Fifthly, the feed forward layer operation may be performed (s270) to uniformly mix a self-attention that each head generates in order to prevent an inclination. When each head performs the self-attention for inputs only based on their points of view, the attention may be inclined according to each head.

After the stack embedding encoder operation (s200) is performed through the 5 operations, the video-category attention operation (s300) may be performed again to generate the final encoding result, like FIG. 2.

The above process may be possible because the video-category attention unit (130) may obtain 4 matrixes and connect them by utilizing the video vector and category vector. The 4 vectors may refer to the similarity matrix (S), the normalized similarity matrix (S′), the video-category similarity (V2C), and the category-video similarity (C2V).

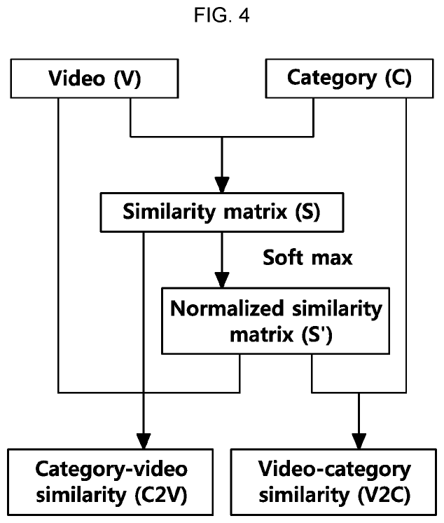

A process to obtain the matrix is illustrated in FIG. 4.

First of all, the similarity matrix (S) may be obtained by utilizing the video (V) and the category information (C). By utilizing the similarity matrix (S), the normalized similarity matrix (S′) may be obtained with a softmax of each column.

Next, the video-category similarity (V2C) may be calculated by utilizing the normalized similarity matrix (S′) and the category information vector. The category-video similarity (C2V) may be calculated by utilizing the similarity matrix (S), the normalized similarity matrix (S′), and the video vector (V) again.

After that, like in FIG. 2, the self-attention operation (s400) may be performed in an output vector obtained from repeating the stack embedding encoder block 3 times, resulting in generating the final encoding result.

As above, after the final encoding result is generated by the encoder module (100), the decoder module (200) may generate an actual sentence by utilizing the result vector of the encoder module (100) (s500). To generate a sentence, the result vector of the encoder may be configured as the initial state of the decoder module (200). Then, a next word may be predicted from the result vector of the encoder and the lastly output word. This prediction may be repeated to generate a caption of a video.

Next, an experiment result for a video caption generation apparatus of the disclosure is compared with other methods. The experiment uses the MSR-VTT data set released by Microsoft in 2017. A Korean data set is established through Korean translation.

[Table 1] below illustrates statistics for a video and reference in the MSR-VTT data set. There are 20 references for a clip.

TABLE 1

| | Number of | Number of | Total |
|---|---|---|---|
| | videos | clips | reference |
| Official data | 7,180 | 10,000 | 200,000 |
| Gathered data | 5,706 | 7,825 | 156,500 |

After the Korean translation, parts of speech are removed through a morpheme analysis. The maximum number of morphemes in a caption is 15, and captions having over 15 morphemes are excluded. Table 2 below illustrates experimental data information.

TABLE 2

| Corpus | Number of videos | Number of references |
|---|---|---|
| Learning corpus | 6,329 | 70,527 |
| Verification corpus | 713 | 9,087 |
| Evaluation corpus | 783 | 9,661 |
| Total | 7,825 | 89,275 |

A basic model compared with a caption generation model of the disclosure is “2D CNN+LSTM” model. That is, 100 key frames are randomly extracted with the same way, and an encoder vector with 128 dimensions is generated through a LSTM-processed result of InceptionV3. A caption of a video is generated with the initial state of LSTM. A word embedding is only utilized, and a dimension of the word embedding is 128 dimensions. The basic model uses 3,500 learning data, and evaluation data are identical. The experiment is conducted according to experiment parameters of Table 3 by randomly extracting 100 video frames. The experiment result is illustrated in Table 4.

TABLE 3

| Parameter | Predetermined value |
|---|---|
| Number of video frames | 100 |
| Video embedding dimension | 2,048 |
| Word embedding dimension | 300 |
| Character embedding dimension | 200 |
| Dropout | 0.1 |
| Learning rate | 0.001 |
| Number of used heads | 2 |

TABLE 4

| Category | B@1 | B@2 | B@3 | B@4 | ROUGE_L | CIDEr |
|---|---|---|---|---|---|---|
| Basic model (Total | 0.631 | 0.323 | 0.198 | 0.121 | | |
| morpheme) | | | | | | |
| Suggested model (15 | 0.640 | 0.490 | 0.392 | 0.313 | 0.500 | 0.237 |
| morphemes or | | | | | | |
| below) | | | | | | |
| Suggested model | 0.663 | 0.506 | 0.404 | 0.321 | 0.494 | 0.116 |
| (Total morpheme) | | | | | | |

According to the experiment result, cases that sentences explaining a video well are generated in an embodiment of the disclosure are: a new word is generated through an additional modification, an action is generated explaining a video more comprehensively, and a sentence is generated by discovering a single context in a video of complex context. The opposite cases are: a video is misunderstood, and words that are not in a dictionary appear a lot. When comparing the results of the basic model and the disclosure, the basic model generates a lot of words that are not in a dictionary, and it does not recognize a dark screen or a change of scenes properly. On the other hand, the suggested model of the disclosure outputs words that are not in a dictionary less than the basic model. It also relatively recognizes an output of complex context properly.

Additionally, without utilizing additional information like 3D CNN, the suggested model of the disclosure may show a good performance, and by utilizing 2D CNN and multi-head self-attention, the disclosure may discover that they are helpful to generate a feature to express a video.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Therefore, the scope of the disclosure is defined not by the detailed description, but by the claims and their equivalents, and all variations within the scope of the claims and their equivalents are to be construed as being included in the disclosure.

### INDUSTRIAL APPLICABILITY

The disclosure may be utilized for an apparatus, etc. to generate a natural language sentence that is desirable to explain a video.

1. A video caption generation apparatus, comprising:
an embedding unit to perform a video embedding and a category information embedding;
a stack embedding encoder block unit to select a feature by utilizing the embedded video vector and category vector;
a video-category attention unit to receive a result of the stack embedding encoder, to generate a similarity matrix and a feature matrix for a video and category information, and to provide a final encoding result; and
a decoder module to generate a sentence by utilizing the final encoding result.

2. The video caption generation apparatus of claim 1,
wherein the embedding unit generates an input video signal as n images and a frame vector through a convolution.

3. The video caption generation apparatus of claim 1,
wherein the category information embedding is generated as a distributed representation by utilizing a word embedding and a character embedding.

4. The video caption generation apparatus of claim 1,
wherein the stack embedding encoder block unit includes a position encoding, a layer normalization, a depthwise separable convolution layer, a self-attention, and a feedforward layer.

5. The video caption generation apparatus of claim 1,
wherein the video-category attention unit calculates a similarity matrix (S), a normalized similarity matrix (S′), a video-category similarity matrix (V2C), and a category-video similarity matrix (C2V) by utilizing a video vector and a category information vector.

6. The video caption generation apparatus of claim 1,
wherein the decoder module generates a caption by repeating a process of predicting a next word from a lastly output word and a result vector of an encoder module.

7. A video caption generating method, comprising:
an embedding operation to process a frame of an input video and to generate an embedding of category information;
a stack embedding encoder operation to select a useful feature by utilizing an embedded video vector and category vector;
a video-category information attention operation to generate a similarity matrix and a feature matrix for a video and category information by utilizing the selected feature information;
a self-attention operation to generate a final encoder result by directly adding a video vector and a category vector into a calculation; and
a decoder operation to generate a sentence by utilizing the generated encoder result.

8. The video caption generating method of claim 7,
wherein the stack embedding encoder operation comprises,
a position encoding operation to apply a weighting according to a frame or word position that appears in video category information;
a layer normalization operation to normalize a distribution of each hidden state and to enable a rapid learning;
a depthwise separable convolution operation repeated as much as predetermined number of layers;
a self-attention operation to generate an embedding by discovering a pair of video and category information for a video and category information that are input respectively, to express oneself appropriately; and
a feedforward layer operation to uniformly mix a self-attention that each head generates in order to prevent an inclination.

9. The video caption generating method of claim 7,
wherein the video-category information attention operation comprises,
obtaining a similarity matrix (S) by utilizing a video (V) and category information (C);
obtaining a normalized similarity matrix (S′) having a softmax for each column by utilizing the similarity matrix (S);
calculating a video-category similarity (V2C) by utilizing the normalized similarity matrix (S′) and the category information vector; and
calculating a category-video similarity (C2V) by utilizing the similarity matrix (S), the normalized similarity matrix (S′), and the video vector (V).
